(19) United States
(12) Patent Application Publication
(10) Pub. No.: US 2026/0229964 A1
(43) Pub. Date: Aug. 6, 2026

(54) MOTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kanzo ISHIHARA, Osaka (JP)

(21) Appl. No.: 19/147,718

(22) PCT Filed: Jan. 9, 2024
(86) PCT No.: PCT/JP2024/000127

§ 371 Date: Jul. 14, 2025

(30) Foreign Application Priority Data
Jan. 25, 2023 (JP) 2023-009116

(51) Int. Cl. H02K 11/20; B60K 7/00; H02K 1/14

(52) U.S. Cl. CPC H02K 11/20; H02K 1/146; B60K 7/0007

(57) ABSTRACT

A motor (100) includes an annular stator (10) and a rotor (20) disposed on an inner circumferential side or outer circumferential side of the stator (10). The stator (10) includes an annular stator core (11) and multi-phase coils (12) attached to the stator core (11). The multi-phase coils (12) each include a plurality of coil portions (1U, 2U, 1V, 2V, 1W, and 2W). The motor (100) further includes a switching unit (30) that switches connection states of the plurality of coil portions (1U, 2U, 1V, 2V, 1W, and 2W) of the coils (12). The switching unit (30) is disposed on the inner circumferential side or outer circumferential side of the stator (10) and the rotor (20).

### TECHNICAL FIELD

The present disclosure relates to a motor.

### BACKGROUND

Patent Document 1 discloses a motor (rotary electric machine). This motor includes a stator core and stator windings wound around the stator core. The stator windings include a plurality of phase windings, each having a first winding and a second winding. The connection state of the first and second windings is switched by a switching unit.

### PRIOR ART DOCUMENT

### Patent Document

Patent Document 1: JP 2017-175852 A

### SUMMARY OF THE INVENTION

### Problems to be Solved

In the technology of Patent Document 1, location of the switching unit is not taken into consideration, and thus there is room for improvement in this regard.

The present disclosure provides a technology that makes it easy to reduce the size of a motor provided with a switching unit in the axial direction.

### Means to Solve the Problem

A motor according to the present disclosure includes an annular stator and a rotor that is disposed on an inner circumferential side or outer circumferential side of the stator, wherein the stator includes an annular stator core and multi-phase coils that are attached to the stator core, the multi-phase coils each include a plurality of coil portions, the motor further includes a switching unit configured to switch a connection state of the plurality of coil portions of the coils, and the switching unit is disposed on an inner circumferential side or outer circumferential side of the stator and the rotor.

### Effect of the Invention

According to the present disclosure, the size of a motor provided with a switching unit can be easily decreased in the axial direction.

### BRIEF DESCRIPTION OF THE DRAWINGS

FIG. 1 is a perspective view of a motor according to a first embodiment.

FIG. 2 is a cross-sectional view of the motor taken along a plane passing through tooth portions in the axial direction.

FIG. 3 is a cross-sectional view of the motor taken along a plane passing through relay switches in the axial direction.

FIG. 4 is a diagram showing a circuit configuration of the motor.

FIG. 5 is a diagram of a motor according to a second embodiment, which corresponds to FIG. 3.

### DETAILED DESCRIPTION TO EXECUTE THE INVENTION

### Description of Embodiments of Present Disclosure

First, embodiments of the present disclosure will be listed and described.
[1] A motor includes an annular stator and a rotor that is disposed on an inner circumferential side or outer circumferential side of the stator, wherein the stator includes an annular stator core and multi-phase coils that are attached to the stator core, the multi-phase coils each include a plurality of coil portions, the motor further includes a switching unit configured to switch a connection state of the plurality of coil portions of the coils, and the switching unit is disposed on an inner circumferential side or outer circumferential side of the stator and the rotor.
Since the switching unit is disposed on the inner circumferential side or outer circumferential side of the stator and the rotor, the size of the above motor can be easily decreased in the axial direction.
[2] In the motor according to [1], the rotor is disposed on the outer circumferential side of the stator, and the switching unit is disposed on the inner circumferential side of the stator.
A space on the inner circumferential side of the stator of the above motor can be used as a housing space for the switching unit.
[3] The motor according to [2] further include a shaft portion that is disposed on an inner circumferential side of the stator core and an annular coupling portion that is coupled to an outer circumferential surface of the shaft portion and an inner circumferential surface of the stator core, wherein the switching unit is disposed in a through hole that passes through the coupling portion in an axial direction.
The stator core of the above motor can be fixed to the shaft portion by the coupling portion. Moreover, in the motor, the switching unit is disposed in the through hole of the coupling portion. For this reason, the switching unit of the motor can be easily disposed at the center in the axial direction, and accordingly, the center of gravity of the motor can be easily prevented from being offset to one side in the axial direction. Note that the coupling portion may be directly coupled to the shaft portion, or may be coupled to the shaft portion via another member. The coupling portion may be directly coupled to the stator core, or may be coupled to the stator core via another member.
[4] In the motor according to [3], a plurality of the through holes are formed in the coupling portion, the plurality of through holes are disposed around the shaft portion, spaced apart from each other in a circumferential direction, the switching unit includes a plurality of relay switches, and the relay switches are respectively disposed in the through holes.
Since the relay switches are disposed around the shaft portion and spaced apart from each other in the circumferential direction, it is easy to reduce mass imbalance in the circumferential direction of the above motor.
[5] In the motor according to [4], a rib is formed on the coupling portion between through holes adjacent in the circumferential direction.
If the through holes are formed in the coupling portion in order to dispose the relay switches, there is a concern that the strength of the coupling portion will decrease due to the formation of the through holes. In the above motor, since a rib is formed on the coupling portion between through holes adjacent in the circumferential direction, it is possible to reinforce areas near the through holes whose strength is likely to decrease.
[6] In the motor according to any one of [3] to [5], the coupling portion includes annular protruding portions that stand upright from peripheral edge portions of the through holes.
If the through holes are formed in the coupling portion in order to dispose the relay switches, there is a concern that the strength of the coupling portion will decrease due to the formation of the through holes. Since the above motor includes the annular protruding portions that stand upright from the peripheral edge portions of the through holes, it is possible to reinforce areas near the through holes whose strength is likely to decrease.
[7] In the motor according to any one of [1] to [6], the switching unit is disposed at a position passing through a center in the axial direction of the stator core.
Since the switching unit is disposed at a position passing through the center in the axial direction of the stator core, the center of gravity of the above motor is likely to be close to the center in the axial direction of the stator core.
[8] The motor according to any one of [1] to [7] is an in-wheel motor that is to be disposed inside a vehicle wheel.
It is easy to reduce the size in the axial direction of the vehicle wheel in which the above motor is provided.

### Details of Embodiments of the Present Disclosure

Specific examples of the present disclosure will be described below with reference to the drawings. Note that the present invention is not limited to illustrations of these, but is indicated by the claims, and is intended to include all modifications that are within the meanings and the scope that are equivalent to those of the claims.

### first Embodiment

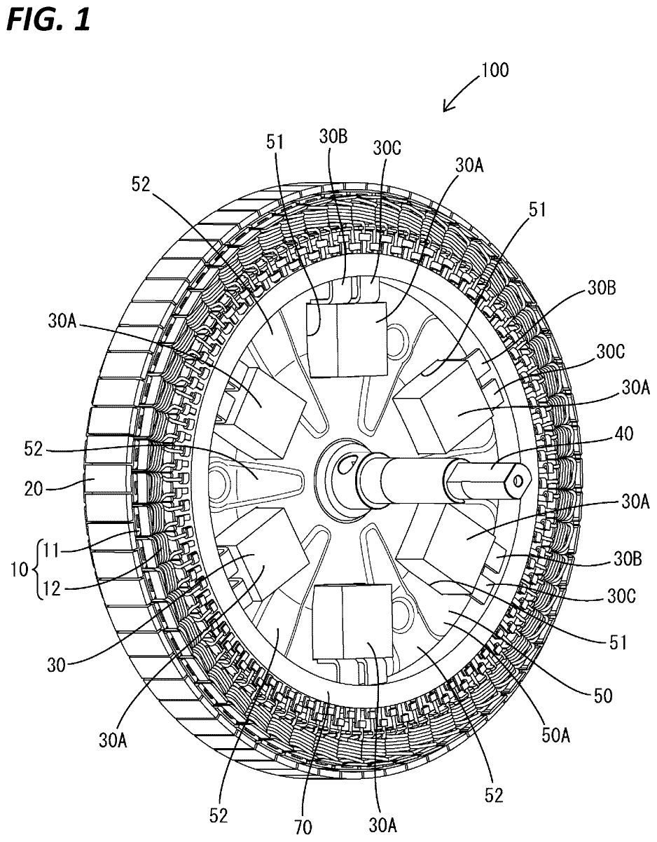

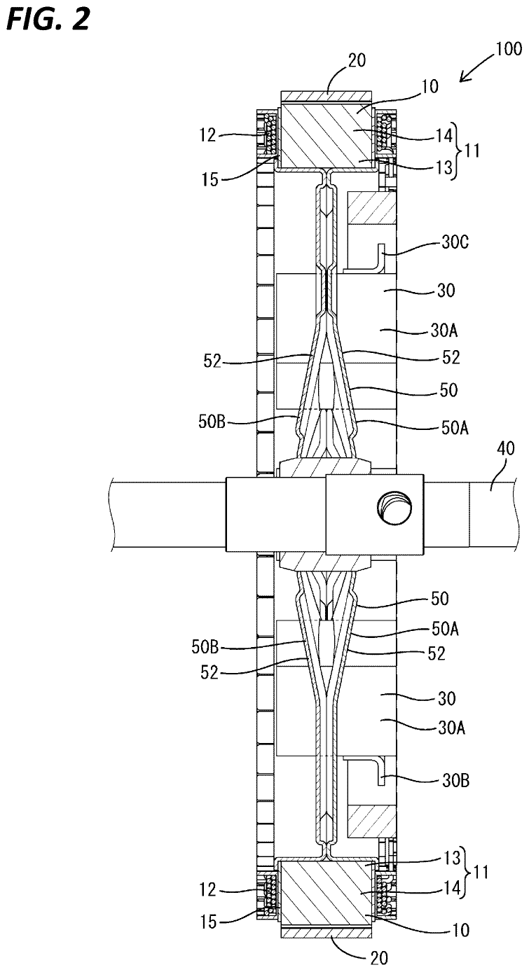

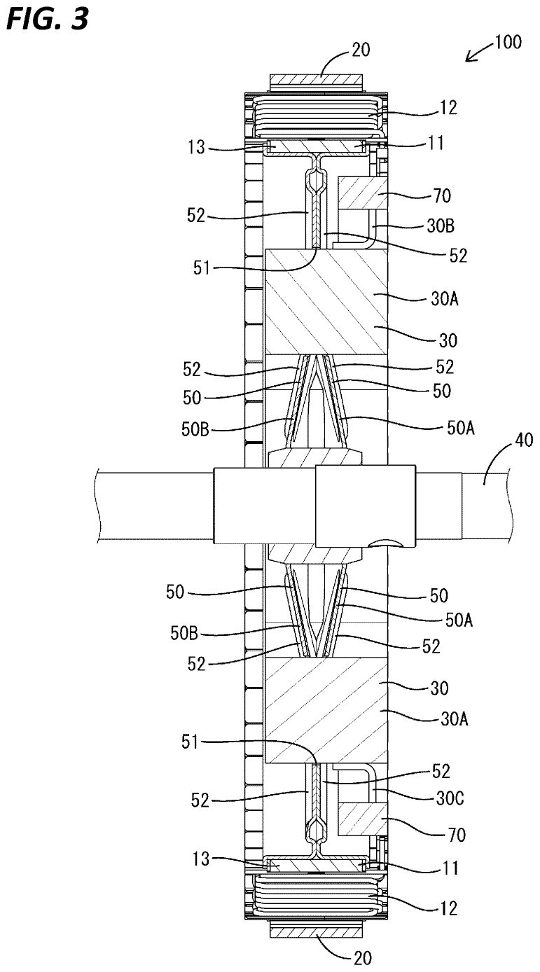

FIGS. 1 to 3 disclose a motor 100 according to a first embodiment. The motor 100 is used to drive a vehicle, for example. The motor 100 is disposed, for example, inside a vehicle wheel, and is used as an in-wheel motor for driving the vehicle wheel. The motor 100 is preferably used as an in-wheel motor of a two-wheeled motor vehicle.

The motor 100 is an outer-rotor type motor. The motor 100 includes a stator 10, a rotor 20, a switching unit 30, a shaft portion 40, and a coupling portion 50.

The stator 10 has an annular shape (more specifically, a circular annular shape). The stator 10 includes a stator core 11 and coils 12.

The stator core 11 is electrically conductive. The stator core 11 may be, for example, a laminated steel plate manufactured by laminating multiple electromagnetic steel sheets (e.g., silicon steel sheets) in the thickness direction, or may be a powder magnetic core formed by press-molding insulation-coated magnetic particles. The stator core 11 has an annular shape (more specifically, a circular annular shape). The stator core 11 includes a yoke portion 13 and a plurality of tooth portions 14. The yoke portion 13 has an annular shape (more specifically, a circular annular shape). The plurality of tooth portions 14 protrude outward in the radial direction from the outer circumference of the yoke portion 13. The plurality of tooth portions 14 are aligned annularly along the outer circumference of the yoke portion 13. The plurality of tooth portions 14 are spaced apart from each other in the circumferential direction.

The coils 12 are attached to the stator core 11. The coils 12 are attached to the stator core 11 via insulating members 15. The coils 12 are wound around the tooth portions 14. The coils 12 are concentrated winding coils in the present embodiment, but do not need to be concentrated winding coils. For example, the coils 12 may be distributed winding coils.

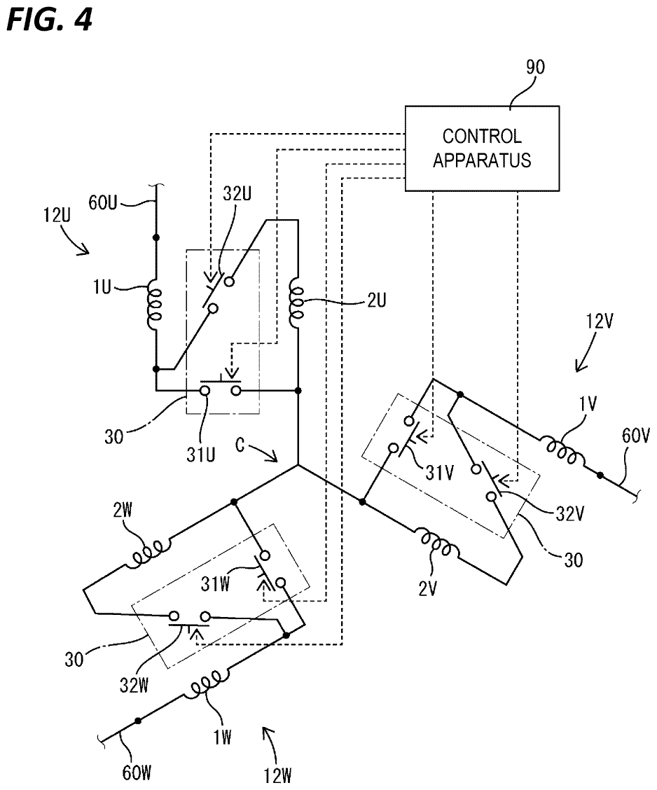

The coils 12 are provided as multi-phase (in the present embodiment, three-phase) coils. In the following description, first-phase coils 12 will be referred to as coils 12U, second-phase coils 12 will be referred to as coils 12V, and third-phase coils 12 will be referred to as coils 12W (see FIG. 4). As shown in FIG. 4, each coil 12U includes a first coil portion 1U and a second coil portion 2U (hereinafter, will also be referred to as coil portions 1U and 2U). Each coil 12V includes a first coil portion 1V and a second coil portion 2V (hereinafter, will also be referred to as coil portions 1V and 2V). Each coil 12W includes a first coil portion 1W and a second coil portion 2W (hereinafter, will also be referred to as coil portions 1W and 2W). That is to say, the multi-phase coils 12 each include a plurality of coil portions 1U, 2U, 1V, 2V, 1W, and 2W. The coil portions 1U, 2U, 1V, 2V, 1W, and 2W are would around the tooth portions 14.

As shown in FIG. 1, the rotor 20 is disposed on the outer circumferential side of the stator 10 (more specifically, the stator core 11). The rotor 20 is disposed on the outer side in the radial direction relative to the outer circumferential surface of the stator 10 (more specifically, the stator core 11). The rotor 20 has an annular shape (more specifically, a circular annular shape). The rotor 20 is constituted by a plurality of magnets. The rotor 20 is disposed on the stator 10 to be rotatable in the circumferential direction.

As shown in FIG. 1, the switching unit 30 is disposed on the inner circumferential side of the stator 10 (more specifically, the stator core 11). The switching unit 30 switches the connection states of the plurality of coil portions 1U, 2U, 1V, 2V, 1W, and 2W of the individual coils 12. In the present embodiment, the switching unit 30 switches the connection states of the plurality of coil portions 1U, 2U, 1V, 2V, 1W, and 2W between a state where only the first coil portions 1U, 1V, and 1W out of the first coil portions 1U, 1V, and 1W and the second coil portions 2U, 2V, and 2W are used and a state where both the first coil portions 1U, 1V, and 1W and the second coil portions 2U, 2V, and 2W are used. The state where both the first coil portions 1U, 1V, and 1W and the second coil portions 2U, 2V, and 2W are used is a state where the second coil portions 2U, 2V, and 2W are connected to the first coil portions 1U, 1V, and 1W in series. In other words, the switching unit 30 switches the number of coils connected in series.

The switching unit 30 includes a plurality of (in the present embodiment, six) relay switches 30A. The relay switches 30A are configured as semiconductor switches such as FETs (Field Effect Transistors). As shown in FIG. 4, the six relay switches 30A are also referred to as relay switches 31U, 32U, 31V, 32V, 31W, and 32W.

As shown in FIG. 4, one end of the first coil portion 1U is electrically connected to a conductive path 60U. The conductive path 60U is connected to an inverter (not illustrated). The other end of the first coil portion 1U is electrically connected to one end of the relay switch 31U and one end of the relay switch 32U. One end of the second coil portion 2U is electrically connected to the other end the relay switch 32U. The other end of the second coil portion 2U is electrically connected to the other end of the relay switch 31U and a conductive path C. The other end of the relay switch 31U is electrically connected to the conductive path C.

When the relay switch 31U is in an on-state and the relay switch 32U is in an off-state, the conductive path 60U is electrically continuous with the conductive path C via only the first coil portion 1U out of the first coil portion 1U and the second coil portion 2U. By switching on the relay switch 31U and switching off the relay switch 32U, the switching unit 30 switches the connection state of the first coil portion 1U and the second coil portion 2U to a state where only the first coil portion 1U out of the first coil portion 1U and the second coil portion 2U is used.

When the relay switch 31U is in the off-state and the relay switch 32U is in the on-state, the conductive path 60U is electrically continuous with the conductive path C, via the first coil portion 1U and the second coil portion 2U connected in series. By switching off the relay switch 31U and switching on the relay switch 32U, the switching unit 30 switches the connection state of the first coil portion 1U and the second coil portion 2U to a state where both the first coil portion 1U and the second coil portion 2U are used.

One end of the first coil portion 1V is electrically connected to a conductive path 60V. The conductive path 60V is connected to an inverter (not illustrated). The other end of the first coil portion 1V is electrically connected to one end of the relay switch 31V and one end of the relay switch 32V. One end of the second coil portion 2V is electrically connected to the other end the relay switch 32V. The other end of the second coil portion 2V is electrically connected to the other end of the relay switch 31V and the conductive path C. The other end of the relay switch 31V is electrically connected to the conductive path C.

When the relay switch 31V is in the on-state and the relay switch 32V is in the off-state, the conductive path 60V is electrically continuous with the conductive path C via only the first coil portion 1V out of the first coil portion 1V and the second coil portion 2V. By switching on the relay switch 31V and switching off the relay switch 32V, the switching unit 30 switches the connection state of the first coil portion 1V and the second coil portion 2V to a state where only the first coil portion 1V out of the first coil portion 1V and the second coil portion 2V is used.

When the relay switch 31V is in the off-state and the relay switch 32V is in the on-state, the conductive path 60V is electrically continuous with the conductive path C via the first coil portion 1V and the second coil portion 2V connected in series. By switching off the relay switch 31V and switching on the relay switch 32V, the switching unit 30 switches the connection state of the first coil portion 1V and the second coil portion 2V to a state where both the first coil portion 1V and the second coil portion 2V are used.

One end of the first coil portion 1W is electrically connected to the conductive path 60W. The conductive path 60W is connected to an inverter (not illustrated). The other end of the first coil portion 1W is electrically connected to one end of the relay switch 31W and one end of the relay switch 32W. One end of the second coil portion 2W is electrically connected to the other end of the relay switch 32W. The other end of the second coil portion 2W is electrically connected to the other end of the relay switch 31W and the conductive path C. The other end of the relay switch 31W is electrically connected to the conductive path C.

When the relay switch 31W is in the on-state and the relay switch 32W is in the off-state, the conductive path 60W is electrically continuous with the conductive path C via only the first coil portion 1W out of the first coil portion 1W and the second coil portion 2W. By switching on the relay switch 31W and switching off the relay switch 32W, the switching unit 30 switches the connection state of the first coil portion 1W and the second coil portion 2W to a state where only the first coil portion 1W out of the first coil portion 1W and the second coil portion 2W is used.

When the relay switch 31W is in the off-state and the relay switch 32W is in the on-state, the conductive path 60W is electrically continuous with the conductive path C via the first coil portion 1W and the second coil portion 2W connected in series. By switching off the relay switch 31W and switching on the relay switch 32W, the switching unit 30 switches the connection state of the first coil portion 1W and the second coil portion 2W to a state where both the first coil portion 1W and the second coil portion 2W are used.

The switching unit 30 (more specifically, the relay switches 31U, 32U, 31V, 32V, 31W, and 32W) is controlled by a control apparatus 90.

As shown in FIG. 1, the shaft portion 40 is disposed on the inner circumferential side of the stator 10 (more specifically, the stator core 11). The shaft portion 40 is disposed on the inner side in the radial direction relative to the inner circumferential surface of the stator core 11. The shaft portion 40 extends along the axial direction of the stator core 11. The shaft portion 40 protrudes outward beyond the two ends of the stator core 11, in the axial direction of the stator core 11. The outer circumferential surface of the shaft portion 40 is surrounded by the stator 10 (more specifically, the stator core 11).

The coupling portion 50 is provided between the shaft portion 40 and the stator core 11, and is coupled to the outer circumferential surface of the shaft portion 40 and the inner circumferential surface of the stator core 11. The coupling method may be, for example, welding, screwing, or another type of coupling method.

The coupling portion 50 has an annular shape. The coupling portion 50 is constituted by two coupling plate portions 50A and 50B. The coupling plate portions 50A and 50B are each formed by performing a bending process and the like on a metal plate member. The coupling plate portions 50A and 50B are disposed to be plane-symmetrical with respect to a plane orthogonal to the axial direction.

A through hole 51 that passes through the coupling portion 50 in the axial direction is formed in the coupling portion 50. The through hole 51 passes through the coupling plate portions 50A and 50B. A plurality of (in the present embodiment, six) through holes 51 are formed in the coupling portion 50. The plurality of through holes 51 are disposed spaced apart from each other in the circumferential direction, around the shaft portion 40. The plurality of through holes 51 are disposed at equal intervals. The number of through holes 51 is the same as the number of relay switches 30A.

The above switching unit 30 (more specifically, the relay switches 30A) is disposed in the through holes 51. The switching unit 30 is disposed at a position passing through the center in the axial direction of the stator core 11. The relay switches 30A are respectively disposed in the through holes 51. The switching unit 30 (more specifically, the relay switches 30A) is fixed to the coupling portion 50. The fixing method may be welding, screwing, or another type of fixing method.

The relay switches 30A each include a first terminal 30B and a second terminal 30C that are electrically connected to coils 12. The first terminal 30B and the second terminal 30C are disposed on one side in the axial direction of the coupling portion 50. The first terminals 30B and the second terminals 30C of all of the relay switches 30A are disposed on the one side in the axial direction of the coupling portion 50. The first terminals 30B and the second terminals 30C of all of the relay switches 30A are electrically connected to the coils 12, on the one side in the axial direction of the coupling portion 50. The first terminals 30B and the second terminals 30C are electrically connected to the coils 12 via wirings inside an insulating resin 70.

Each Rib 52 is formed on the coupling portion 50, between through holes 51 adjacent in the circumferential direction. The ribs 52 are respectively formed on the coupling plate portions 50A and 50B. The ribs 52 formed on the coupling plate portions 50A and 50B protrude outward in the axial direction. The width of the ribs 52 increases toward the outer side in the radial direction.

The size in the axial direction of the motor 100 according to the first embodiment can be easily reduced since the switching unit 30 is disposed on the inner circumferential side of the stator 10 and the rotor 20 as described above. Furthermore, the motor 100 can use a space on the inner circumferential side of the stator 10 as a housing space for the switching unit 30.

In the motor 100, the stator core 11 can be fixed to the shaft portion 40 by the coupling portion 50. Moreover, in the motor 100, the switching unit 30 is disposed in the through holes 51 of the coupling portion 50. For this reason, the switching unit 30 of the motor 100 can be easily disposed at the center in the axial direction, and accordingly, the center of gravity of the motor 100 can be easily prevented from being offset to one side in the axial direction.

Since the relay switches 30A are disposed spaced apart from each other in the circumferential direction, around the shaft portion 40, and thus it is easy to reduce mass imbalance in the circumferential direction of the motor 100.

If the through holes 51 are formed in the coupling portion 50 in order to dispose the relay switches 30A, there is a concern that the strength of the coupling portion 50 will decrease due to the formation of the through holes 51. In the motor 100, each rib 52 is formed on the coupling portion 50, between through holes 51 adjacent in the circumferential direction, and thus it is possible to reinforce areas near the through holes 51 whose strength is likely to decrease.

The switching unit 30 is disposed at a position passing through the center in the axial direction of the stator core 11, and thus the center of gravity of the motor 100 is likely to be close to the center in the axial direction of the stator core 11.

In a case where the motor 100 is disposed inside a vehicle wheel, it is easy to reduce the size in the axial direction of the vehicle wheel in which the motor 100 is provided.

### Second Embodiment

A motor according to a second embodiment is different from the motor according to the first embodiment in that the coupling portion includes annular protruding portions that stand upright from peripheral edge portions of through holes, and is the same in other respects. Note that, in the second embodiment, the same configurations as the first embodiment are given the same reference numerals, and a detailed description thereof is omitted.

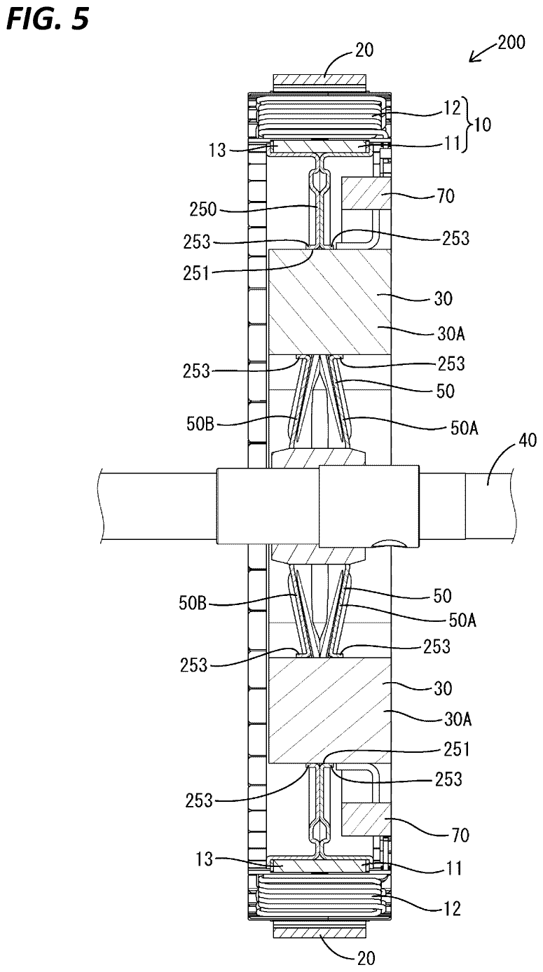

As shown in FIG. 5, a motor 200 according to the second embodiment includes the stator 10, the rotor 20, the switching unit 30, the shaft portion 40, and a coupling portion 250.

Through holes 251 are formed in the coupling portion 250. The coupling portion 250 includes annular protruding portions 253 that stand upright from peripheral edge portions of the through holes 251. The protruding portions 253 are formed in an annular shape along the through holes 251. The protruding portions 253 are formed, for example, by burring.

If the through holes 251 are formed in the coupling portion 250 in order to dispose the relay switches 30A, there is a concern that the strength of the coupling portion 250 will decrease due to the formation of the through holes 251. The motor 200 according to the second embodiment includes the annular protruding portions 253 that stand upright from the peripheral edge portions of the through holes 251, and thus it is possible to reinforce areas near the through holes 251 whose strength is likely to decrease.

### Other Embodiments of Present Disclosure

Embodiments disclosed herein are examples in all respects and should not be interpreted as limiting in any manner.
(1) In the above embodiments, a configuration is adopted in which the rotor is disposed on the outer circumferential side of the stator, but a configuration may also be adopted in which the rotor is disposed on the inner circumferential side of the stator. In the above embodiments, a configuration is adopted in which the switching unit is disposed on the inner circumferential side of the stator and the rotor, but a configuration may also be adopted in which the switching unit is disposed on the outer circumferential side of the stator and the rotor.
(2) In the above embodiments, a configuration is adopted in which the switching unit switches the number of coil portions connected in series, but another configuration may also be adopted. For example, a configuration may be adopted in which the switching unit switches a plurality of coil portions between connection in series and connection in parallel.

### LIST OF REFERENCE NUMERALS

1U First coil portion (coil portion)
1V First coil portion (coil portion)
1W First coil portion (coil portion)
2U Second coil portion (coil portion)
2V Second coil portion (coil portion)
2W Second coil portion (coil portion)
10 Stator
11 Stator core
12 Coil
12U Coil
12V Coil
12W Coil
13 Yoke portion
14 Tooth portion
15 Insulating member
20 Rotor
30 Switching unit
30A Relay switch
30B First terminal
30C Second terminal
31U Relay switch
31V Relay switch
31W Relay switch
32U Relay switch
32V Relay switch
32W Relay switch
40 Shaft portion
50 Coupling portion
50A Coupling plate portion
50B Coupling plate portion
51 Through hole
52 Rib
60U Conductive path
60V Conductive path
60W Conductive path
70 Insulating resin
90 Control apparatus
100 Motor
200 Motor
250 Coupling portion
251 Through hole
253 Protruding portion
C Conductive path

1. A motor comprising:
an annular stator; and
a rotor that is disposed on an inner circumferential side or outer circumferential side of the stator,
wherein the stator includes an annular stator core and multi-phase coils that are attached to the stator core,
the multi-phase coils each include a plurality of coil portions,
the motor further includes a switching unit configured to switch a connection state of the plurality of coil portions of the coils, and
the switching unit is disposed on an inner circumferential side or outer circumferential side of the stator and the rotor,
the switching unit includes a plurality of relay switches,
each of the relay switches includes a first terminal and a second terminal, and
the first terminals and the second terminals protrude outward in a radial direction, and are electrically connected to the coils.

2. (canceled)

3. The motor according to claim 1, further comprising:
a shaft portion that is disposed on an inner circumferential side of the stator core; and
an annular coupling portion that is coupled to an outer circumferential surface of the shaft portion and an inner circumferential surface of the stator core,
wherein the switching unit is disposed in a through hole that passes through the coupling portion in an axial direction.

4. The motor according to claim 3,
wherein a plurality of the through holes are formed in the coupling portion,
the plurality of through holes are disposed around the shaft portion, spaced apart from each other in a circumferential direction,
the switching unit includes a plurality of relay switches, and
the relay switches are respectively disposed in the through holes.

5. The motor according to claim 4,
wherein a rib is formed on the coupling portion between through holes adjacent in the circumferential direction.

6. The motor according to claim 3
wherein the coupling portion includes annular protruding portions that stand upright from peripheral edge portions of the through holes.

7. The motor according to claim 1,
wherein the switching unit is disposed at a position passing through a center in the axial direction of the stator core.

8. The motor according to claim 1 being an in-wheel motor that is to be disposed inside a vehicle wheel.
